(19) United States
(12) Patent Application Publication
(10) Pub. No.: US 2001/0045913 A1
(43) Pub. Date: Nov. 29, 2001

(54) Manually operable mechanism permitting elevation angle adjustment for a satellite antenna

(76) Inventors: Ronald L. Fedder, Colowater, TN (US); Timothy B. Crowson, Madison, AL (US)

Correspondence Address: Pillsbury Winthrop LLP, Intellectual Property Group, Ninth Floor, 1100 New York Avenue, NW, Washington, DC, 20005-3918, US

(21) Appl. No.: 09/773,635

(22) Filed: Feb. 2, 2001

Related U.S. Application Data
(60) Provisional application No. 60/180,202, filed on Feb. 4, 2000.

(51) Int. Cl. H01Q 3/00; H01Q 3/02

(52) U.S. Cl. 343/882; 343/763

(57) ABSTRACT

The present invention relates to a system for mounting a satellite antenna in a manner to facilitate adjustment of the elevation angle without the use of tools or the need of significant artificial light. The system includes a movable bracket pivotably mounted to a fixed bracket. The satellite antenna is mounted to the movable bracket. A manually operable connector is connected to the movable bracket and the fixed bracket to permit manual adjustment of the elevation angle.

### CROSS-REFERENCE

This application claims the benefit of U.S. Provisional Application No. 60/180,202, filed Feb. 4, 2000, which is incorporated herein by reference.

### BACKGROUND OF THE INVENTION

1. Field of the Invention

The present invention relates to a mechanism by which the elevation angle of a satellite antenna can be adjusted without the use of tools.

2. Description of Related Art

With the increased popularity and availability of satellite-based information and entertainment transmissions, such as satellite-based television programming, and internet, satellite antennas (e.g., dish antennas) for receiving satellite signals are being mounted on mobile vehicles, such as recreational vehicles and semi tractors, to provide satellite signal access for the mobile vehicle.

In order to receive satellite signals, the satellite antenna must be placed in an orientation by which the signals can reach the antenna and be focused and reflected into a receiver. This requires that the azimuth and the elevation angle of the antenna be adjusted to preferred settings depending on the location of the satellite antenna relative to the transmitting satellite. With fixed-based satellite antennas, such as those used on residential homes, the proper azimuth and elevation angles are set with tools in the day time at antenna installation, and because the satellites used for transmitting signals are geosynchronous, the angles do not need to be further adjusted.

With vehicle-based satellite antennas, on the other hand, the azimuth and elevation angles cannot be set one time and thereafter left unadjusted. For one thing, some satellite antennas must be stowed when the vehicle is actually moving to prevent damage to the satellite antenna due to wind and debris. Thus, the orientation of the antenna cannot be left unchanged when the satellite antenna is stowed, and the azimuth and elevation angles must be reset every time the antenna is re-deployed, both during the day and night. Furthermore, because the vehicle is mobile, the location at which the satellite antenna is deployed changes from deployment to deployment. Therefore, the satellite antenna's position relative to the geosynchronous satellites changes. Thus, the azimuth and elevation angles must be reset every time the antenna is re-deployed both during the day and night.

There are presently a number of commercially available mechanisms for mounting satellite antennas to vehicles. One such mechanism for deployably mounting a satellite antenna to the back surface of a vehicle is disclosed in U.S. Pat. No. 5,961,092, the contents of which are hereby incorporated by reference, and is commercially available from Satellite Mobile Systems, Incorporated of Madison, Ala. under the trade name Polekat™. Another mechanism for deployably mounting a satellite antenna, such as a dish, to a vehicle is commercialized by Winegard, Inc. of Burlington, Iowa. Another commercially available mechanism for mounting a satellite dish to a vehicle has been commercialized by Datron, a division of Transco, Inc. which is based in Simi Valley, Calif., DBS-3000”, “DBS-4000” and “CruiseTV.” Another commercially available mechanism for mounting a satellite antenna to a vehicle has been commercialized by KVH Industries, Inc., which is based in Middletown, R.I., under the trademark “TracVision.”

These mechanisms have some means by which the azimuth angle of the satellite dish can be adjusted and set at the time of deployment. For example, with the system disclosed in U.S. Pat. No. 5,961,092, the satellite antenna is mounted atop a rotatable pole that is telescopically coupled to another fixed pole. The antenna can be rotated atop the rotatable pole to thereby adjust the azimuth angle of the antenna, and a locking mechanism is provided to selectively lock the rotatable pole with respect to the fixed pole to thereby set the azimuth angle. Setting the elevation angle is not, however, so easy. The satellite antenna is typically carried on a bracket that can pivot in a vertical plane to allow the elevation angle to be adjusted. A nut and bolt arrangement is provided to arrest the pivoting motion of the bracket to thereby fix the selected elevation angle of the antenna. Accordingly, at least one tool, such as a wrench, is required to selectively loosen or tighten the bolt and nut of the pivoting bracket to thereby allow the antenna elevation angle to be adjusted and to thereafter fix the antenna in the desired elevation angle. In addition, the elevation angle indicators stamped on the side of the bracket cannot be easily read at night even with the aid of artificial light.

### SUMMARY OF THE INVENTION

There is consequently a need in the art for a mechanism to mount a satellite antenna to a vehicle in manner that easily facilitates manual adjustment of the elevation angle of the satellite antenna without the need for tools, or other adjustment devices, and can be done during the day or at night.

Consistent with the principles of the present invention as embodied and broadly described herein, an exemplary embodiment includes a satellite antenna mounting system configured to mount a satellite antenna. The mounting system comprises a fixed bracket adapted to be mounted to an object and a movable bracket pivotably attached to the fixed bracket. The satellite antenna is mounted on the movable bracket. The mounting system also includes a manually operable connector connected to the fixed bracket and the movable bracket. The connector is manually loosenable to permit adjustment of an elevation angle of the satellite antenna relative to the fixed bracket and manually tightenable to fix relative positions of the fixed bracket and the movable bracket. The ease of obtaining the elevation angle is enhanced with the utilization of a reflective material having the range of elevation angles printed thereon, and when combined with an elongated pointer, makes setting the elevation angle very easy during the night as well as during the day.

### BRIEF DESCRIPTION OF THE DRAWINGS

The accompanying drawings, which are incorporated in and constitute a part of this specification, illustrate preferred embodiments of the invention and, together with the description, explain the objects, advantages, and principles of the invention. In the drawings:

FIG. 1 is a perspective view of a mechanism for deployably mounting a satellite antenna to a vehicle, with the antenna in a stowed position;

FIG. 2 illustrates the mechanism of FIG. 1 after deployment of the satellite antenna;

FIG. 3 is a side view of a satellite antenna and the manually operable mechanism of the present invention;

FIG. 4 is a partial perspective view of the manually operable mechanism of the present invention;

FIG. 5 is a cross-section along line 5-5 in FIG. 4;

FIG. 6 is a side elevation of the manually operable mechanism with the antenna set in a first elevation angle;

FIG. 7 is a side elevation of the manually operable mechanism with the antenna set in a second elevation angle; and

FIG. 8 is an enlarged perspective view of a manually operable securing member.

### DETAILED DESCRIPTION OF PREFERRED EMBODIMENTS

The following detailed description of the present invention refers to the accompanying drawings that illustrate exemplary embodiments consistent with this invention. Other embodiments are possible and modifications may be made to the embodiments without departing from the spirit and scope of this invention. Therefore, the following detailed description is not meant to limit the invention.

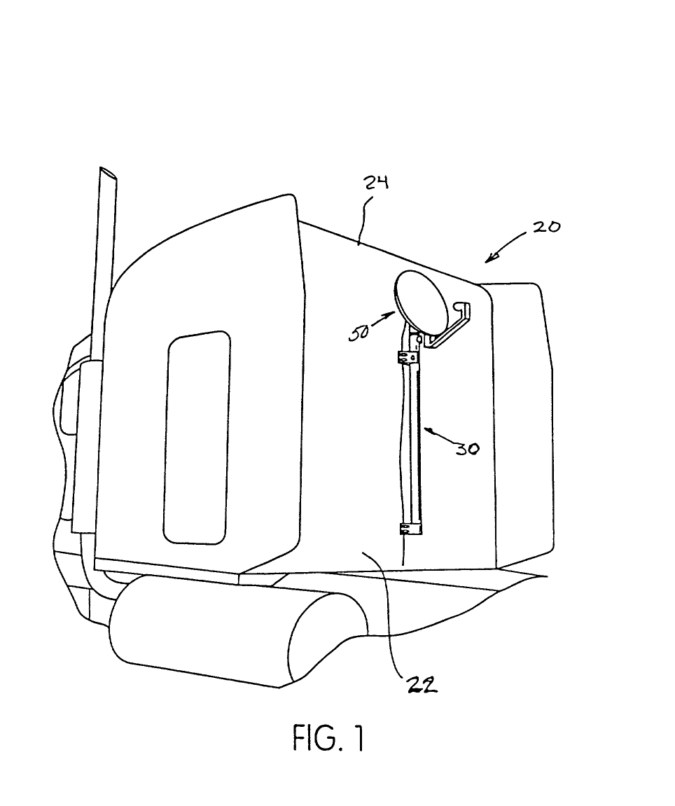

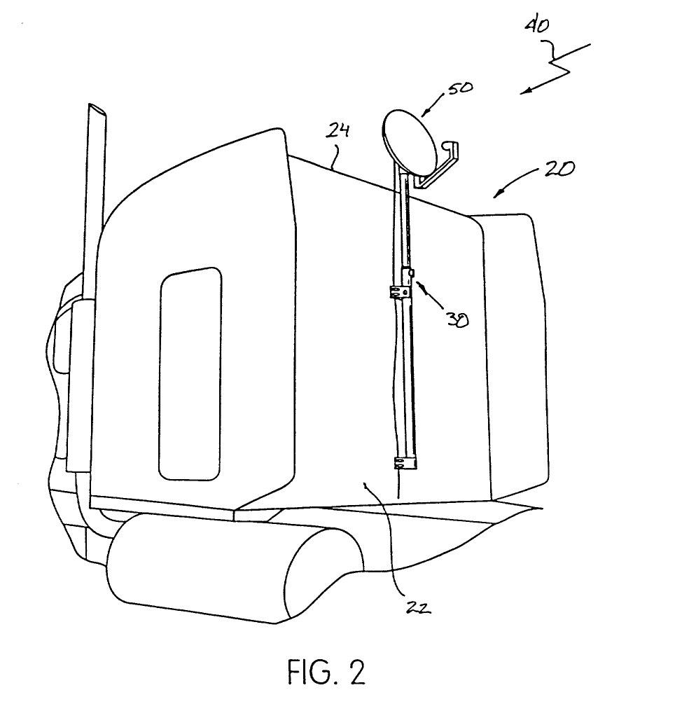

A vehicle, generally indicated at 20, is partially shown in FIGS. 1 and 2. In the Figures, the vehicle comprises a semi tractor. A satellite antenna 50 is attached to a back surface 22 of the vehicle 20 by means of a mounting mechanism 30 attached to the back surface 22 of the vehicle 20. In the illustrated embodiment, the mounting mechanism 30 comprises a telescopic pole assembly of the type disclosed in U.S. Pat. No. 5,961,092 incorporated above. It will be understood, however, that the mechanism of the present invention can be used in conjunction with any mechanism for mounting a satellite antenna to a vehicle.

FIG. 1 shows the mounting mechanism 30 arranged so that the satellite antenna 50 carried thereby is in a stowed position. That is, the satellite antenna 50 is positioned below a top portion 24 of the vehicle 20. By being stowed below the top portion 24 of the vehicle 20, the satellite antenna 50 is protected from wind and debris during forward movement of the vehicle 20.

In FIG. 2, the mounting mechanism 30 is shown holding the satellite antenna 50 in a deployed position. In the deployed position, the satellite antenna 50 carried by the deployable mounting mechanism 30 is disposed above a top portion 24 of the vehicle 20, so that the antenna 50 is able to receive satellite signals 40.

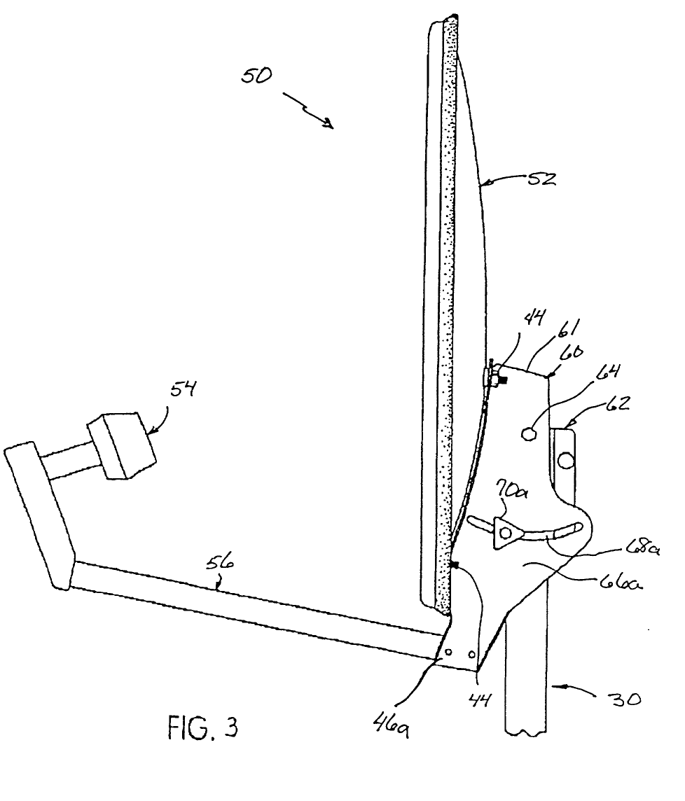

As shown in FIG. 3, the satellite antenna 50 includes a focusing/reflecting dish 52 and a receiver element 54 operatively positioned on a receiver arm 56 so as to be able to receive satellite signals reflected and focused by the dish 52.

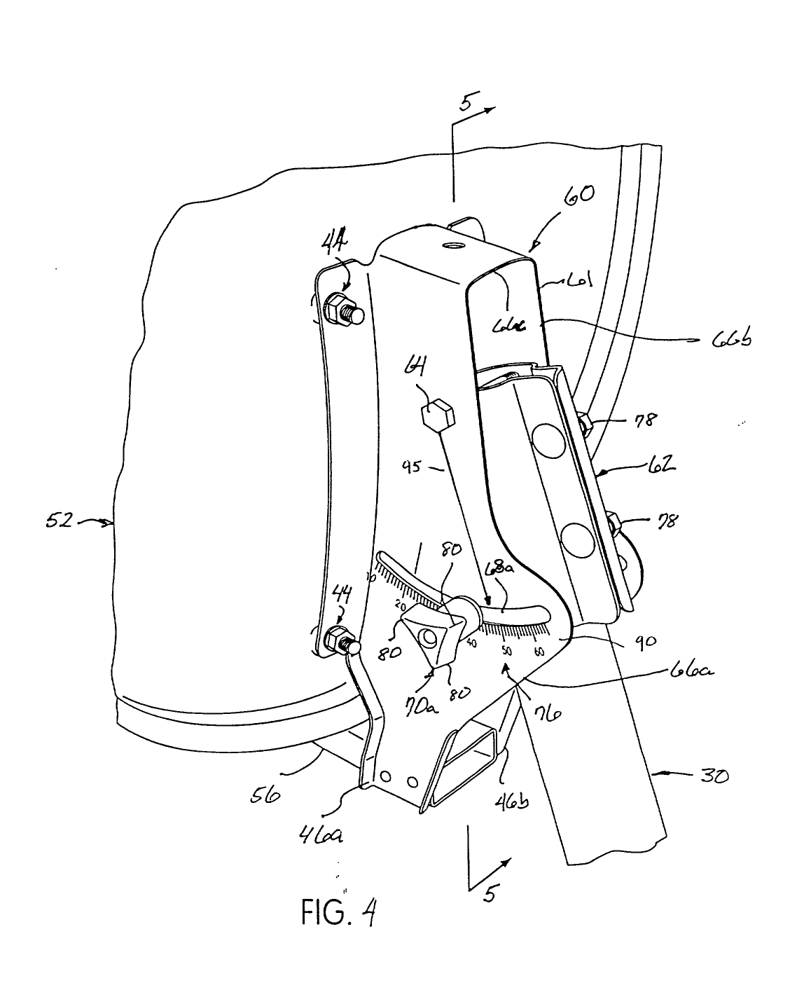

The details of the antenna mounting bracket 60 are shown in FIGS. 3-5. As shown in FIG. 4, the antenna mounting bracket 60 includes a U-shaped member 61 defined by a left side panel 66a and a right side panel 66b which are arranged in generally parallel, spaced relation with respect to each other and are attached to one another at respective upper ends thereof by a connecting panel 66c. The receiver arm 56 is attached to the mounting bracket 60 between opposed lower attachment flanges 46a and 46b at the lower ends of the left side panel 66a and right side panel 66b, respectively. The receiver arm 56 is attached to the flanges 46a and 46b by means of rivets, welding, screws, bolts or other suitable fastening mechanisms.

The antenna mounting mechanism 60 further includes a fixed portion 62 that is fixed to the deployable mounting mechanism 30 and with respect to which the U-shaped member 61 can pivot. In the illustrated embodiment, the fixed portion 62 is a cylindrical clam style bracket which is attached to the telescopic pole of the mounting mechanism 30 and is secured thereto by means of bolts 78 tightening the fixed portion 62 onto the telescopic pole. The U-shape member 61 is pivotally attached to the fixed portion 62 by means of a pivot pin 64. In the illustrated embodiment, pivot pin 64 comprises a bolt extending through aligned apertures formed in the left side panel 66a, the fixed portion 62, and the right side panel 66b.

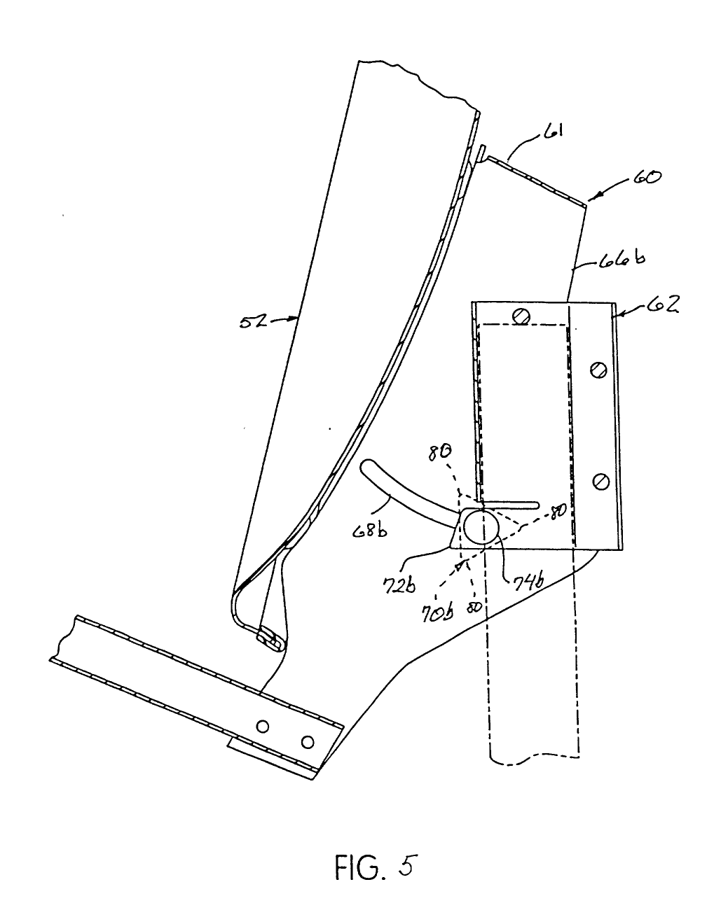

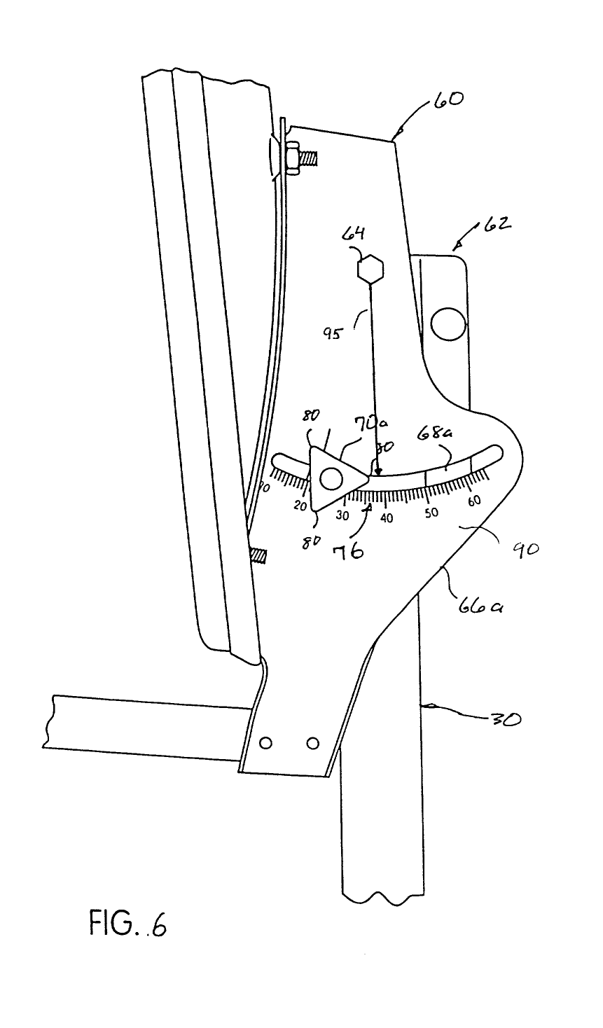

The elevation angle of the focusing/reflecting dish 52 can be adjusted and set by pivoting the U-shaped member 61 with respect to the fixed portion 62 fixed to the deployable mounting mechanism 30 and thereafter fixing the U-shaped portion 61 in a desired angle with respect to the fixed portion 62. As shown in FIG. 5, a securing tab 72b extends laterally from a lower end of the fixed portion 62 of the mounting bracket 60. FIG. 5 is a transverse cross-section of the mounting bracket 60, and therefore, only the right side securing tab 72b is shown. A left side securing tab extends laterally from a left side of the fixed portion 62 but is not shown in the Figures. An appropriately shaped aperture is formed through the right side securing tab 72b, and a right side securing post 74b extends through the aperture formed in the securing tab 72b and through a right side arcuate slot 68b formed in the right side panel 66b. In the preferred embodiment, the aperture formed through the right side securing tab 72b is a square opening, and the right side securing post 74b is a carriage bolt having a square boss formed beneath a head thereof configured and sized to be operatively received within the square aperture formed in the securing tab 72b. A right side manually operable securing member 70b engages the right side securing post 74b on the side of the right side panel 66b opposite the securing tab 72b and can be tightened onto a post 74b to draw the securing tab 72b into frictional engagement with an inner surface of the right side panel 66b to thereby secure the U-shape member 61 with respect to the fixed portion 62. As shown in FIGS. 3, 4 and 6-7, the antenna mounting brackets also includes a left side manually operable securing member 70a that engages a left side securing post (not shown) extending through a left side arcuate slot 68a formed in the left side panel 66a.

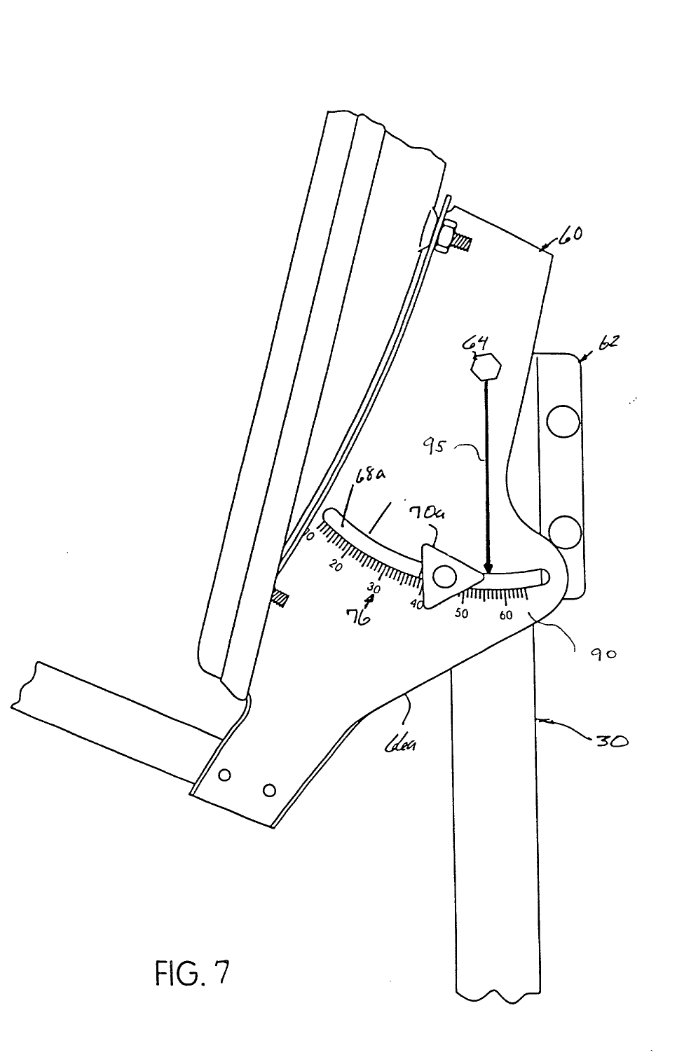

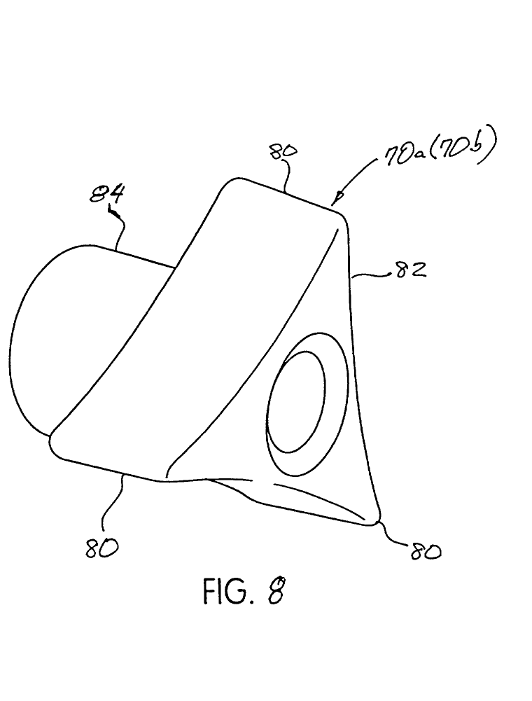

As shown in FIGS. 7 and 8, the manually operable securing members 70a, 70b are manually operable connectors including a handle portion 82 and a cylindrical portion 84 having an internally threaded bore formed therein that engages the external threads of the associated securing post extending through the corresponding arcuate slot 68a, 68b. As shown, the handle portion 82 is triangular in shape with three apexes 80. The triangular shape and the apexes 80 permit the securing members 70a, 70b to be manually tightened and loosened onto and from the securing posts. Accordingly, the U-shaped member 61 of the antenna mounting bracket 60 and the focusing/reflecting dish 52 attached to the U-shaped member 61 can be pivoted with respect to the fixed portion 62 and, by means of the manually operable securing members 70a, 70b and their associated securing posts, can be fixed in a desired elevation angle without the need for tools.

An angular scale 76 is preferably provided along a lower edge of the left side arcuate slot 68a formed in the left side panel 66a. The scale 76 assists a user in setting the dish 52 at a specified elevation angle. Typically, an operator can determine a preferred elevation angle for a given location by searching through a database, and determining the required elevation angle for a given location. For example, a truck driver at a rest stop can look-up the elevation angle and other signal acquisition information based on, for example, the zip code of the location at which he happens to be. Thereafter, knowing this information, the truck driver can then set the dish 52 at the desired elevation angle, using the scale 76 and without the need for tools, before deploying the satellite antenna 50 and while it is in a position that is easily accessible. Furthermore, with the utilization of a reflective surface material 90 having the elevation angles printed thereon and an elongated pointer 95 connected to the pivot pin 64 to indicate a selected angle (e.g., constructed of brass or other similar material), setting the elevation angles becomes very easy during the night as well as during the day.

The foregoing description of the preferred embodiments provides an illustration and description, but is not intended to be exhaustive or to limit the invention to the precise form disclosed. Modifications and variations are possible consistent with the above teachings or may be acquired from practice of the invention.

What is claimed is:

1. A satellite antenna mounting system configured to mount a satellite antenna, the mounting system comprising:
a fixed bracket adapted to be mounted to an object;
a movable bracket pivotably attached to the fixed bracket, the satellite antenna being mounted on the movable bracket; and
a manually operable connector connected to the fixed bracket and the movable bracket, the connector being manually loosenable to permit adjustment of an elevation angle of the satellite antenna relative to the fixed bracket and manually tightenable to fix relative positions of the fixed bracket and the movable bracket.

2. A satellite antenna mounting system according to claim 1, further comprising at least one securing post, the at least one securing post including a bolt having a head and a boss disposed beneath the head, the boss having a predetermined shape.

3. A satellite antenna mounting system according to claim 2, wherein the fixed bracket includes a number of securing portions, the securing portions being adapted to cooperate with the at least one securing post to facilitate the adjustment of the elevation angle.

4. A satellite antenna mounting system according to claim 3, wherein the securing portions include a number of apertures formed therein, at least one of the apertures having a shape that matches the predetermined shape.

5. A satellite antenna mounting system according to claim 4, wherein the at least one securing post is configured to be inserted through the apertures.

6. A satellite antenna mounting system according to claim 5, wherein the boss is configured to be received within the aperture having the predetermined shape.

7. A satellite antenna mounting system according to claim 6, wherein the connector is configured to frictionally engage the at least one securing post to secure the movable bracket with respect to the fixed bracket.

8. A satellite antenna mounting system according to claim 2, wherein the movable bracket includes at least a left panel and a right panel, each panel including a number of slots configured for slidably engaging the at least one securing post to provide a range of angles through which the elevation angle can be adjusted.

9. A satellite antenna mounting system according to claim 8, further comprising:
a pivot portion; and
an elongated indicator fixedly connected to the pivot portion, the elongated indicator being configured to indicate a selected elevation angle from the range of angles.

10. A satellite antenna mounting system according to claim 8, wherein each of the number of slots is arc-shaped.

11. A satellite antenna mounting system according to claim 10, wherein a surface of each panel is formed of a light reflective material.

12. A satellite antenna mounting system according to claim 10, further comprising an angular scale printed on at least one surface of the left and right sides and positioned along at least one of the arc-shaped slots, the reflective material being formed on the one surface to facilitate nocturnal adjustment of the elevation angle.

13. A satellite antenna mounting system according to claim 1, wherein the movable bracket is substantially U-shaped.

14. A satellite antenna mounting system according to claim 1, wherein the movable bracket includes a number of lower attachment portions adapted for positioning at least one other antenna mounting system component thereto.

15. A satellite antenna mounting system according to claim 14, wherein the at least one other antenna mounting system component includes a receiver arm.

16. A satellite antenna mounting system according to claim 15, wherein the attachment portions include at least two flanges, the receiver arm being fixedly connected therebetween.

17. A satellite antenna mounting system according to claim 1, wherein the object is a movable mast.

18. A satellite antenna mounting system according to claim 1, wherein the connector has a triangular shape.

19. A method for assembling a satellite antenna mounting system, the antenna mounting system including:
a fixed bracket including at least one aperture configured to adjustably secure an antenna;
an elongated indicator disposed in cooperative arrangement with the fixed bracket;
a movable bracket configured for being attached to the fixed bracket, the movable bracket including a number of slots to facilitate adjustment of an antenna elevation angle between a range of angles;
wherein the elongated indicator is configured to indicate a selected angle from the range of angles;
at least one securing post configured to cooperate with the apertures and the movable bracket to provide the range of angles; and
a manually operable connector structured to frictionally engage the at least one securing post, the method comprising:
mounting the fixed bracket to an object;
pivotably attaching the movable bracket to the fixed bracket at a pivot point;
inserting the at least one securing post through the number of slots and the apertures; and
attaching the connector to one end of the at least one securing post such that the movable bracket pivots about the pivot point and the securing post moves within the number of slots when the movable member pivots, the movement within the slots corresponding to the adjustment between the range of angles.

20. A method for assembling a satellite antenna mounting system according to claim 19, further comprising mounting the antenna to the movable member.

21. A method for assembling a satellite antenna mounting system according to claim 19, wherein the attaching includes threadedly engaging the connector and the at least one securing post.

22. A method for assembling a satellite antenna mounting system according to claim 19, wherein the attaching includes (i) threadedly engaging the connector with the at least one securing post and (ii) manually tightening the connector to secure the movable member.

23. A method for adjusting an elevation angle of a satellite antenna mounted to a satellite antenna mounting system, the antenna mounting system including:
a fixed bracket adapted to be mounted to an object;
a movable bracket pivotably attached to the fixed bracket at a pivot point, the satellite antenna being mounted on the movable bracket; and
a manually operable connector connected to the fixed bracket and the movable bracket, the connector being manually loosenable to permit adjustment of the elevation angle of the satellite antenna relative to the fixed bracket and manually tightenable to fix relative positions of the fixed bracket and the movable bracket, the method comprising:
determining a preferred elevation angle for the satellite antenna;
manually adjusting a position of the satellite antenna to the preferred elevation angle, the movable member pivoting at the pivot point when the elevation angle is adjusted; and
performing one of (i) manually loosening the connector to adjust the elevation angle and (ii) manually tightening the connector to secure the movable member.

24. A method for assembling a satellite antenna mounting system, the antenna mounting system including:
a fixed bracket including at least one aperture configured to adjustably secure the antenna;
a movable bracket configured for being attached to the fixed bracket, the movable bracket including a number of slots to facilitate adjustment of an antenna elevation angle between a range of angles;
at least one securing post configured to cooperate with the apertures and the movable bracket to provide the range of angles; and
a manually operable connector structured to frictionally engage the at least one securing post, the connector being manually loosenable to permit adjustment of the elevation angle of the satellite antenna, the method comprising:
mounting the fixed bracket to an object;
pivotably attaching the movable bracket to the fixed bracket at a pivot point;
inserting the at least one securing post through the number of slots and the apertures; and
attaching the connector to one end of the at least one securing post such that the movable bracket pivots about the pivot point and the securing post moves within the number of slots when the movable member pivots, the movement within the slots corresponding to the adjustment between the range of angles.
